(19) United States
(12) Patent Application Publication
(10) Pub. No.: US 2012/0031847 A1
(43) Pub. Date: Feb. 9, 2012

(54) Oil spill remediation, oil recovery product and process

(76) Inventor: Kraig Shook, Tequesta, FL (US)

(21) Appl. No.: 12/806,177

(22) Filed: Aug. 5, 2010

(51) Int. Cl. C02F 1/28; B01J 20/22

(52) U.S. Cl. 210/691; 502/401

(57) ABSTRACT

An oil sorbent material particularly for removing an oil slick from water is hydrophobic, in the form of a free-flowing dry powder, and preferentially absorbs oil from the slick, forming buoyant clumps which are easily skimmed or screened from water. Absorbed oil can be recovered from the clumps of sorbent material by several methods including solvent extraction, and heating to liquefy or vaporize the absorbed oil, allowing recovery of a significant fraction of oil spilled on or in water.

### BACKGROUND OF THE INVENTION

1. Field of the Invention

The present invention relates generally to a product for remediation of oil spilled upon or into water, for recovery of spilled oil, and to a process of use. That is, the present inventive product allows not only for substantial removal of spilled oil (i.e., both crude oil and petroleum distillates, or oil-based products) from a watery environment by absorption, but also provides for a significant portion of the spilled oil to be recovered for refining or other uses. More Particularly, this invention relates to an oil spill remediation product in the form of a dry, free-flowing, hydroscopic and oil-absorbent powder, that itself is natural and not poisonous, toxic, or harmful to the environment. Further, the product contains no acidic, or caustic constituents, no nutrients which would promote algae growth, and no VOC's (volatile organic compounds—as some so-called “oil dispersants do). Similarly, the sorbent product according to this present invention includes no detergents (which themselves can do significant damage to the environment, perhaps by inclusion in the detergent formulation of phosphates or similar chemical compounds). Additional aspects of the present invention include the advantage that the spilled oil after recovery (i.e., removal of the spilled oil from a watery natural environment) can be substantially recovered from the sorbent material for refining or other uses. Also, the inventive product can be used to de-oil wildlife and other animals who have come in contact with and been fouled by spilled oil and oil-based products

2. Related Technology

Spilled oil (i.e., petroleum lost, for example, from oil wells at the surface of the earth, or underwater, or from transportation facilities, such as oil tanker ships, rail road oil tank cars, or highway tank trucks) represents a serious environmental hazard—in part because of the sheer volume of spilled oil. Almost always oil spills of large volume inevitably result in part of the spilled oil making its way into the natural watery environment. This may happen as a result of runoff of spilled oil into streams or rivers, or by run off into storm drains, for example. Alternatively, the spill may take place into a lake, river, or channel, or directly into a sea or ocean. In all cases, action must be taken promptly to prevent immediate and long-term damage to the environment and ecology (including to wildlife, birds, and other animals) as a result of the spilled oil. Moreover, much smaller but still serious quantities of spilled oil may occur at motor vehicle service facilities or at manufacturing facilities and factories, for example, and also represent an environmental hazard requiring remediation. Such spills also may result in run off into storm drains, or into streams or rivers, for example.

Federal, State, and local laws and regulations attempt to reduce or limit the possibilities of such spills, and to require clean up efforts in order to limit the scope of the environmental and ecological damage. But, many of these laws, regulations, and efforts are simply ineffective in the face of major oil spills, such as that occurring at the British Petroleum platform in the Gulf of Mexico in 2010.

A sorbent material which has been tried to remove a slick of spilled oil from water is hydroscopic calcium stearate. This material has the advantage of not absorbing water, but of absorbing oil. As a result, the broadcasting of hydroscopic calcium stearate upon a body of water having an oil slick would seem to offer the advantage of absorbing the oil, and removing the spilled oil from the body of water. Unfortunately, what happens if fact is that the hydroscopic calcium stearate absorbs a portion of the oil slick, and then soon sinks. Accordingly, the spilled oil is not removed from the body of water, but becomes a long-term contaminant on the bottom of the body of water. This long-term contaminant on the bottom of the body of water can contaminate or poison bottom-dwelling fish, animals, and plants. Thus, the use of hydrophobic calcium stearate alone has not proved to be a viable candidate for remediation of spilled oil on water. A similar criticism applies to dispersant materials, such as the product Corexit®, which British Petroleum (BP) insisted on using in very large quantities in the Gulf of Mexico. That is, a significant part of the supposedly “dispersed” oil sinks and remains on the bottom as a toxic sludge in the Gulf.

Stated differently, and from a different perspective, many of the oil dispersant products currently in the market (including Corexit®), are proprietary products with unknown (and possibly toxic or hazardous) ingredients, and have also proved not to be entirely satisfactory in actually doing the job for which they are promoted—of removing spilled oil from a watery environment. In part this is the case because dispersants, even when apparently effective, remove none of the spilled oil from a body of water and can leave sunken residues, as noted above. The argument presented in favor of the use of these dispersants is that naturally-occurring bacterial and microbial action will reduce the spilled oil to a harmless condition over time. But, what exactly “over time” means in terms of years, decades or centuries, is not specified by the proponents of these products. So, again, how much time is required for the spilled oil to be reduced to a harmless condition is never specified, nor is the question answered of how much toxic or poisonous effect the oil will have in its “dispersed” form before it is reduced to supposedly harmless materials. And, because the ingredients of the dispersant are themselves unknown, the short-term and long-term effects on the environment and ecology of a body of water (in the case of the BP spill in the Gulf of Mexico—the entire Gulf at least may be affected) of introducing the dispersant itself are totally unknown.

Accordingly, although various oil absorbent and oil dispersant products have been proposed, and some have been utilized with greater or lesser degrees of success in various oil spill situations, additional and alternative solutions and products for oil spill remediation are needed.

### SUMMARY OF THE INVENTION

In view of the deficiencies of the conventional related technology, it is an object of this invention to overcome or reduce one or more of these deficiencies.

Accordingly, one particularly preferred embodiment of the present invention provides a dry, buoyant, free-flowing powder oil-sorbent product which is hydrophobic (water hating) and which will not absorb water when broadcast upon water with an oil slick. This dry powder absorbent preferentially absorbs petroleum and petroleum distillate products (i.e., the sorbate) and forms buoyant clumps which float and which are easily recovered by skimming from the water surface.

A further aspect of the present invention is to use the dry powder hydrophobic oil-sorbent product by broadcasting this dry powder on water containing spilled oil, providing time for the product to absorb spilled oil and form clumps (preferably with agitation, as may occur naturally because of wave action, or with artificial agitation of the water), collecting the clumped product and absorbed oil from the water, and processing the clumped product and absorbed oil to recover a significant portion of the spilled oil (i.e., to recover the sorbate).

Another aspect of the present invention involves recovery of absorbed oil from the clumped product. This oil recovery according to one embodiment of the invention involves a solvent extraction of the spilled oil from the recovered product, and recovery of a significant portion of the spilled oil from the solvent used in the solvent extraction.

According to yet another embodiment of the present invention, recovery of absorbed oil from the product involves a heating process, allowing the absorbed spilled oil to be fluidized and drained from the product, or allowing the absorbed spilled oil to be vaporized and condensed once again to a liquid.

For example, after the product with absorbed oil is recovered from the environment, and after a significant portion of the recovered oil is recovered for use, the remaining product with a residue of oil can be utilized. For example, the product with a residue of absorbed oil may itself be burned as a fuel. The burning of such recovered product and oil residue can be accomplished without significant modification to a number of contemporary furnaces, such as those at coal-fired power generation plants. Alternatively, the recovered absorbent product and oil residue, with proper conditioning, may be used as a road paving material, as an underlayment for traditional road paving materials, or as a road patching material (i.e., pot hole filler).

Other objects, features, and advantages of the present invention will be apparent to those skilled in the art from a consideration of the following detailed description of a preferred exemplary embodiment thereof taken in conjunction with the associated figures which will first be described briefly.

### BRIEF DESCRIPTION OF THE DRAWING FIGURES

FIG. 1 provides a diagrammatic view of a body of water having a slick of spilled oil thereon;

FIG. 2 provides a very greatly enlarged view of a carrier vehicle and flotation material carrying much smaller particles of an oil absorbent material entangled or intercalated therewith;

FIG. 3 is a diagrammatic illustration of clumped floating sorbent material upon a cleaned body of water preparatory to screening this material from the water surface;

FIG. 4 is a schematic illustration of a solvent extraction process for recovery of absorbed spilled oil from sorbent material according to this invention, and

FIG. 5 provides a diagrammatic illustration of a heating process for recovery of absorbed spilled oil from sorbent material according to this invention.

### DETAILED DESCRIPTION OF AN EXEMPLARY PREFERRED EMBODIMENT OF THE INVENTION

While the present invention may be embodied in many different forms, disclosed herein are specific exemplary embodiments and processes which illustrate and explain the principles of the invention. In conjunction with the description of this embodiment, methods or processes of removing spilled oil from a body of water, and of recovering the absorbed spilled oil are provided. It should be emphasized that the present invention is not limited to the specific embodiments illustrated, but is intended to be limited only by the scope and spirit of the appended claims, which also provide definition of the invention.

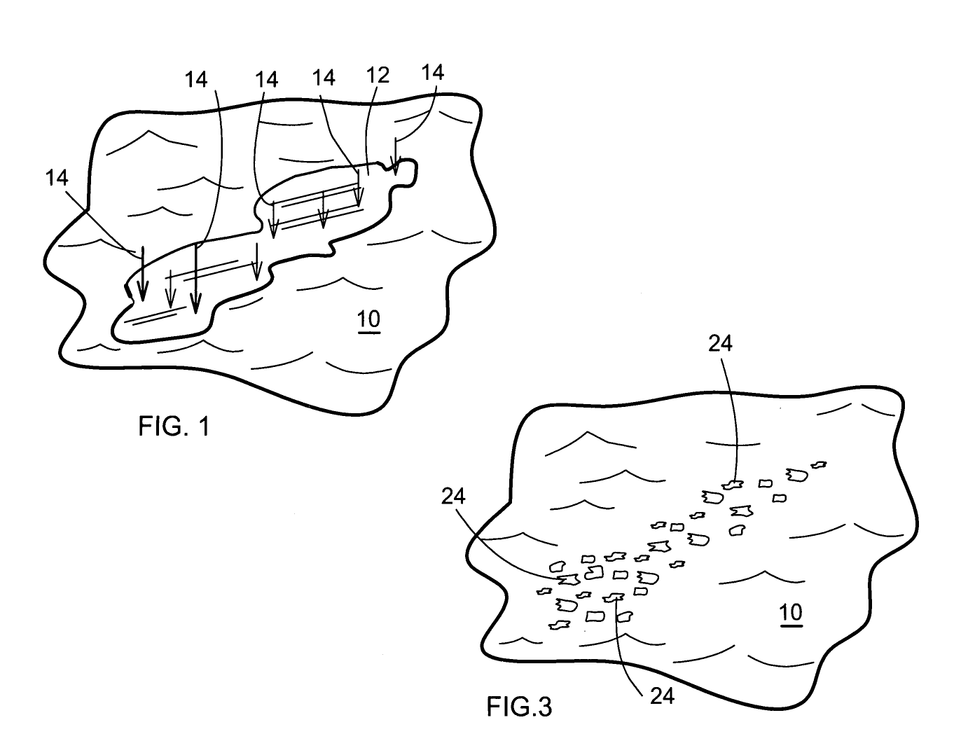

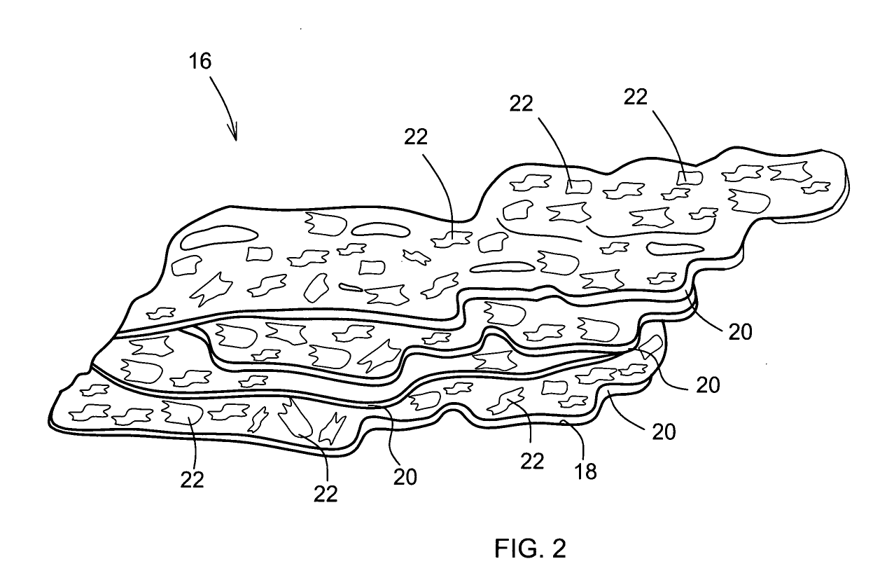

Turning attention now to FIG. 1, a body of water 10 is diagrammatically illustrated. Floating upon this body of water 10 is a slick 12 of spilled oil. Arrows 14 in FIG. 1 illustrate the broadcasting, spreading, or dispersing upon the water 10, and particularly upon the slick 12 of spilled oil, of a free-flowing granular or powder sorbent material 16 (seen in FIG. 2) according to this invention.

FIG. 2 illustrates a much-magnified view of a single granule of the sorbent material 16. This sorbent material consists essentially of two cooperating parts or ingredients, and includes a vehicle or flotation carrier granule preferably of exfoliated vermiculite 18. As is seen in the illustration of FIG. 2, exfoliated vermiculite includes plural lamina, or plate-like bodies 20, which in the exfoliated state of the vermiculite material are spaced apart to both define an extended surface area, and to define many crevices. Prior to exfoliation of the vermiculite material 18 these lamina 20 were tightly packed folia, or foliated masses, essentially of mica, and are closely adjacent to one another. However, exfoliation of the vermiculite material 18 results in the lamina 20 being spaced apart, and in the lamina cooperatively forming an extended surface area for the granule of sorbent material seen in FIG. 2. In bulk, the exfoliated vermiculite preferred for use in this invention is a comparatively light and fine-grained material, having a weight of about seven pounds per cubic food, and a granule size about like granulated sugar, or somewhat larger.

Further, intercalated with the lamina 20 of the vermiculite (i.e., so as to be carried upon and within the vermiculite) is seen a great multitude of ultra-fine particles 22 consisting of hydrophobic calcium stearate (hereinafter “HCS”). As mentioned above, hydrophobic calcium stearate is recognized as a preferential absorber of oil, and does not absorb water (i.e., it is hydrophobic). But, HCS by itself is also not satisfactory as a sorbent to remove oil from water because it and the absorbed oil soon sink. Most preferably, the HCS is a very fine particulate material, with at least 90% of the particles passing through a 325 mesh screen (i.e., opening size 0.0017 inch).

In contrast to the conventional sorbent technology, the sorbent material according to this invention includes a carrier material (i.e., including exfoliated vermiculite) that provides buoyancy and flotation to the hydroscopic calcium stearate. That carrier and flotation material according to the most preferred embodiment of the present invention is composed essentially of exfoliated vermiculite 18 as explained, although the invention is not so limited, and other floatation agents may be utilized. That is, it is to be understood that other buoyant flotation materials may be used in combination with the preferred oil sorbent material of HCS.

According to the present invention, the exfoliated vermiculite granules and the ultra-fine granules of hydroscopic calcium stearate are brought together in such a way that the HCS is carried by the vermiculite. Preferably, the sorbent product includes from about 35% to about 65% by weight of HCS. Most preferably, the sorbent product includes substantially 50% by weight of HCS. In other words, according to one preferred recipe for the present inventive sorbent material, one cubic food of granular exfoliated vermiculite (approximately 7 pounds in weight) has added to it preferably about 4½ pounds of HCS in ultra-fine powder or particulate form, and these ingredients are combined by mixing. A powered mixer is preferably utilized for this purpose, although manual mixing, or tumbling together of the ingredients are also viable alternatives. Essentially, the mixing together of these two ingredients is carried out sufficiently that the HCS ingredient is incorporated into and is carried by the exfoliated vermiculite ingredient (recalling FIG. 2). Once properly mixed together, the HCS substantially does not separate from the exfoliated vermiculite.

Returning to a consideration of the removal of oil spilled into water, and as is illustrated in FIG. 3, it is seen that following the dispersal on the oil slick 12 of sorbent material 16 and the passage of time (preferably during agitation—which can be provided by natural wave action, for example) the oil of slick 12 will have been essentially entirely absorbed by the sorbent material 16 (i.e., the oil is a sorbate within the now-clumped sorbent material 16). It will be recognized that agitation of the oil slick and sorbent material can be accomplished by other (i.e., artificial) means, such as by traversing the oil slick with a motorboat, for example. As FIG. 3 more particularly illustrates, the absorbed oil causes the sorbent material 16 to form cohesive clumps 24 which are buoyant, and float allowing their removal from the water 10 by skimming or screening, for example.

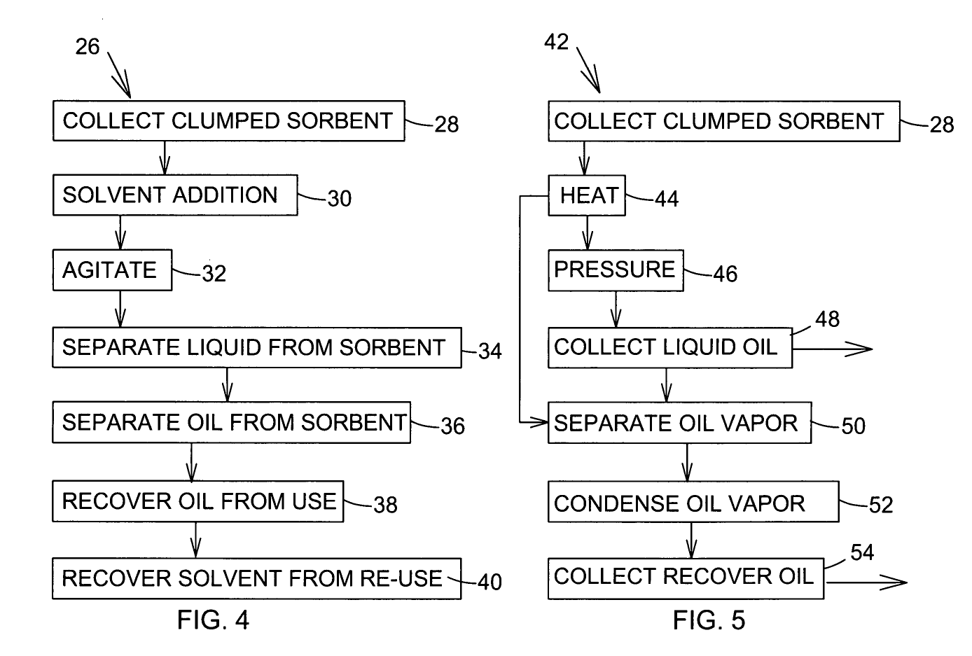

FIG. 4 schematically illustrates a method (i.e., process generally indicated with arrowed numeral 26) for recovering the absorbed oil from the sorbent material after the clumps of sorbent material (with absorbed oil) have been screened or skimmed, for example, from the body of water 10. As step 28 indicates, the clumps of sorbent material along with absorbed oil are collected, and then as step 30 indicates, a solvent is added to the collected clumps of sorbent material. Step 32 indicates that agitation is applied, preferably in the form of agitation sufficient to break apart the clumps of sorbent material and to thus expose the absorbed oil to the solvent to an effective degree. Step 34 indicates that the resulting solvent/oil liquor is drained from the sorbent material and is retained for further processing. Steps 30-34 may be repeated with the sorbent material as thus processed in order to remove additional absorbed oil, and to provide additional quantity of solvent/oil liquor for further processing. Step 36 indicates that the solvent is removed from the oil fraction of the solvent/oil liquor. This step 36 may be accomplished, for example, by a vacuum distillation process, which is well understood in the relevant arts. Step 38 indicates that step 36 results in the recovery of oil, which may be used for additional refining steps to produce useful petroleum distillates. Also, step 40 indicates that step 36 results in the recovery of a significant portion of the solvent used at step 30, so that this solvent may again be recycled for other uses, or may be re-used in the subject process at step 30.

Turning now to FIG. 5, an alternative method of recovering a significant fraction of the spilled oil from the clumped sorbent material is schematically illustrated. Attention to FIG. 5 will indicate that this process generally involves heating the collected clumped sorbent material (with absorbed oil). Further, the method of FIG. 5 includes an alternative of simply heating the sorbent material so that the oil is liquefied and can be pressed out of the sorbent material for recovery, or of heating the sorbent material sufficiently that the oil is vaporized and is recovered by condensation. Turning attention to the details of FIG. 5, step 28 is the same as discussed above, and simply indicates that the clumps of sorbent material (and absorbed oil) are collected. Step 44 indicates that heat is applied to the collected clumps of sorbent material and absorbed oil. This heating step 44 may be continued so that the absorbed oil is reduced in viscosity (i.e., is partially or fully liquefied), whereupon step 46 indicates that the sorbent material is subjected to pressing in order to press out the recovered oil. Step 48 indicates that the recovered oil is collected for further processing as desired.

Alternatively, the heating of step 44 may be continued to a sufficiently high temperature that the absorbed oil is vaporized. Step 44 may be carried out at reduced pressure (i.e., at partial vacuum) in order to assist in drawing out the vapors of the recovered oil. Step 50 indicates that the vapors of the recovered oil are collected, while step 52 indicates that these collected oil vapors are condensed. Step 54 indicates that condensation of the recovered oil vapors results in recovery of a significant fraction of the absorbed oil, which is collected for further processing or uses as desired.

An important alternative use for the present oil-sorbent product is as a de-oiling material useful for saving animals, including wildlife, birds, and other animals, who have been fouled by spilled oil. In this use, the sorbent product may (if desired) include a lesser percentage of HCS (i.e., 35% or less by weight), so that the sorbent product overall is lighter in weight and “fluffier” to perhaps be better tolerated and less stressful for the animals when they have the material poured, or sprinkled, for example, on their skin, coat, or feathers. This lighter, fluffier version of the present sorbent product is especially advantageous when the product is used in “dry immersion” of animals who have a fur coat or feathers and who are heavily oiled. In such a “dry immersion” the animal is placed into a tub or other receptacle of suitable size and the space around the animal is filled with sorbent according to this invention. Of course, the animal's head is left out of the sorbent, and sufficient time is allowed for the sorbent to “pull” oil from the animal's coat or feathers. It is though that many animals will well tolerate this “dry immersion” process, and the advantages of removing oil from their fur or feathers without the use of detergents may be important in saving many animals that otherwise will die of the stresses associated with the conventional methods including first being oil-fouled, and then being handled and scrubbed with detergents. Further, in contrast to the conventional use of solvents or detergents on oil-fouled animals, the present sorbent material does not strip natural feather and skin oils from the animal, so the animals viability after being de-oiled by use of this sorbent product is believed to be improved over conventional methods. Again, for lightly oiled animals, the sorbent product can be poured or sprinkled upon the animals to absorb oil from the animal's coat, skin, or feathers. After absorbing oil, the sorbent material can be brushed off the animal, taking the absorbed oil with it, and leaving the animal de-oiled. Repeating this process of sprinkling the sorbent product on the oiled parts of the animal followed by brushing the sorbent product off (carrying absorbed oil with it) substantially de-oils the animal. On the other hand, heavily oiled birds and animals can be temporarily “dry immersed” in the sorbent de-oiling product. After a time thus immersed in the sorbent, the animal is removed from the receptacle and sorbent material with absorbed oil is brushed off the animals coat, skin, or feathers.

Those skilled in the art will further appreciate that the present invention may be embodied in other specific forms without departing from the spirit or central attributes thereof. Because the foregoing description of the present invention discloses only particularly preferred exemplary embodiments of the invention, it is to be understood that other variations are recognized as being within the scope of the present invention. Further to the above, it is to be understood that the HCS material utilized in making the sorbent material according to this invention can be further or additionally processed to make is more than usually hydroscopic. This additional processing may include, for example, addition of a water-excluding but oil-permeable sealant or surfactant, such as a paraffin, to the HCS. Accordingly, the present invention is not limited to the particular embodiment which has been described in detail herein. Rather, reference should be made to the appended claims to define the scope and content of the present invention.

I claim:

1. A buoyant oil-sorbent product for oil spill remediation by absorption of spilled oil from water, so as to form buoyant clumps which can be skimmed from the water surface, said product comprising; hydrophobic calcium stearate in ultra-fine particulate form, said hydroscopic calcium stearate being carried by a buoyant flotation material also in granular form, whereby broadcasting of said product upon water having thereon a slick of spilled oil results in said hydroscopic calcium stearate particles preferentially absorbing the spilled oil while said flotation material provides buoyancy so that said product and absorbed oil forms buoyant floating clumps which remain on the surface of the water and can be skimmed there from.

2. The buoyant oil-sorbent product of claim 1 wherein said buoyant flotation material includes exfoliated vermiculite in fine granular form.

3. The buoyant oil-sorbent product of claim 2 wherein said exfoliated vermiculate defines a great multitude of crevices and an extended surface area, and said hydroscopic calcium stearate being resident upon and within said exfoliated vermiculite so that the latter carries and provides buoyancy to particles of hydroscopic calcium stearate.

4. The buoyant oil-sorbent product of claim 1 wherein said hydroscopic calcium stearate comprises from about 35% to about 65% by weight of said product.

5. The product of claim 1 wherein said hydroscopic calcium stearate comprises substantially 50% by weight of said product.

6. The product of claim 1 wherein said hydroscopic calcium stearate is additionally processed to make it more strongly hydrophobic.

7. A method of oil spill remediation for a body of water having a slick of spilled oil or oil product thereon, said method comprising steps of:
providing a buoyant oil-sorbent product in the form of a dry free-flowing hydroscopic powder;
broadcasting said product upon said water, and allowing said product to absorb spilled oil from said body of water and to form buoyant floating clumps on the water surface; and
collecting said buoyant floating clumps of said product and absorbed oil from the water surface.

8. The method of oil spill remediation of claim 7 further including the step of utilizing in said buoyant oil-sorbent product of hydroscopic calcium Stearate as an oil-sorbent.

9. The method of oil spill remediation of claim 7 further including the step utilizing in said buoyant oil-sorbent product exfoliated vermiculite in fine granular form as a flotation material.

10. The method of oil spill remediation of claim 9 further including the step of providing for said exfoliated vermiculate to define a great multitude of crevices and an extended surface area, combining said exfoliated vermiculite and said hydroscopic calcium stearate so that said hydroscopic calcium stearate is resident upon and within said exfoliated vermiculite, whereby each granule of said exfoliated vermiculite carries and provides buoyancy to a great number of fine-dimension particles of hydroscopic calcium stearate.

11. The method of oil spill remediation of claim 7 further including the step of providing said buoyant oil-sorbent product with fine-dimension particles of hydroscopic calcium stearate comprising from about 35% to about 65% by weight of said product.

12. The method of oil spill remediation of claim 11 further including the step of including in said product fine-dimension particles of hydroscopic calcium stearate comprising substantially 50% by weight of said product.

13. The method of oil spill remediation of claim 7 further including the step of further processing said hydroscopic calcium stearate to make it more strongly hydrophobic while still preferentially absorbing oil and oil-based materials.

14. A buoyant oil-sorbent product for oil spill remediation by absorption of spilled oil, said oil-sorbent product forming buoyant clumps which can be skimmed from a water surface, said product comprising;
hydrophobic calcium stearate in ultra-fine particle form; and
said hydroscopic calcium stearate being carried by a buoyant flotation material also in granular form;
said buoyant flotation material including exfoliated vermiculite in granular form defining a great multitude of crevices and an extended surface area;
said granular exfoliated vermiculite and said ultra-fine particulate hydroscopic calcium stearate being mixed together sufficiently that said hydroscopic calcium stearate becomes resident upon and within said exfoliated vermiculite so that the latter carries and provides buoyancy to particles of hydroscopic calcium stearate;
whereby broadcasting of said product upon water having thereon a slick of spilled oil or oil-bases material results in said hydroscopic calcium stearate particles preferentially absorbing the spilled oil while said flotation material provides buoyancy so that said product and absorbed oil forms buoyant floating clumps which remain on the surface of the water and can be skimmed there from.

15. The buoyant oil-sorbent product of claim 14 wherein said hydroscopic calcium stearate comprises from about 35% to about 65% by weight of said product.

16. The product of claim 14 wherein said hydroscopic calcium stearate comprises substantially 50% by weight of said product.

17. The product of claim 14 wherein said hydroscopic calcium stearate is additionally processed to make it more strongly hydrophobic.
